(19) United States
(12) Patent Application Publication
(10) Pub. No.: US 2026/0302622 A1
(43) Pub. Date: Oct. 1, 2026

(54) ANTENNA ASSEMBLY WITH OUTER COIL ENCOMPASSING PATCH ANTENNA

(71) Applicant: MOTOROLA MOBILITY LLC, WILMINGTON, DE (US)

(72) Inventors: JUNSHENG ZHAO, VERNON HILLS, IL (US); XUYUAN PAN, CHICAGO, IL (US); MD FAISAL ABEDIN, LAKE BLUFF, IL (US); MOHAMMED ABDUL-GAFFOOR, PALATINE, IL (US)

(21) Appl. No.: 19/094,963

(22) Filed: Mar. 30, 2025

(51) Int. Cl. H01Q 9/04; H01Q 1/24; H01Q 5/25; H01Q 7/00; H01Q 21/28

(52) U.S. Cl. CPC H01Q 9/0407; H01Q 1/241; H01Q 5/25; H01Q 7/00; H01Q 21/28

(57) ABSTRACT

A communication device has an integrated antenna assembly of a collectively smaller footprint by nesting a patch antenna within a coil. The antenna assembly includes a first ferrite layer positioned on and supported by a first ground plane. The coil is positioned over and supported by the first ferrite layer and has a first interior perimeter edge. The patch antenna has a first footprint size that is smaller than, and positioned within, the first interior perimeter edge of the coil. In an example, the patch antenna may be configured to perform functions of one or more of a global positioning system antenna, a satellite communication antenna, and an ultra-wideband (UWB) antenna). The coil may be configured to perform functions of at least one of a near field communication (NFC) antenna and a wireless charging (WLC) coil.

### BACKGROUND

### 1. Technical Field

The present disclosure relates generally to mobile communication devices, and more particularly to mobile communication devices that include multiple antennas/coils that occupy a spatial footprint.

### 2. Description of the Related Art

Portable communication devices, particularly smartphones, have become ubiquitous. Antennas are incorporated into the portable communication devices to support communications in one or more radio frequency (RF) bands using one or more communication protocols. Locations within the portable communication devices for antennas are limited by the overall small size of the portable communication devices and by one or more displays that can cover a front side and portions of a back side of the device. Cameras integrated into the device also compete for space. Some RF bands may be supportable by antennas positioned along thin lateral edges of the communication device. However, some antennas need to be on the front side or the back side of the device due to the size of the antenna. In an example, coils that support near field communication (NFC) and wireless charger (WLC) require a two-dimensional spatial footprint. In another example, patch antennas are configured for global positioning system (GPS) reception, satellite communication, and an ultra-wideband (UWB) transceiving. With some portable communication devices, the device is configured such that an upper back portion of the device may be positioned to “tap” a point of sale device for performing a transaction using the NFC antenna.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 is a top view of a first antenna assembly including a patch antenna positioned “in plane” within an inner aperture of a ferrite layer that supports a coil that encompasses the patch antenna, according to one or more embodiments;

FIG. 3 is a side cutaway view of the first antenna assembly of FIG. 2, according to one or more embodiments;

FIG. 4 illustrates graphical plots of realized peak gain in decibels as a function of frequency of a right hand circular polarized (RHCP) patch antenna with and without an integrated near field communication (NFC) antenna, according to one or more embodiments;

FIG. 5 is a top view of a second antenna assembly that includes a second ferrite layer on top of the first antenna assembly, according to one or more embodiments;

FIG. 6 is a side cutaway view of the second antenna assembly of FIG. 5, according to one or more embodiments;

FIG. 7 is a top view of a third antenna assembly including a patch antenna positioned “off plane” on top a second ground plane that is encompassed by the coil, according to one or more embodiments;

FIG. 8 is a side cutaway view of the first antenna assembly of FIG. 7, according to one or more embodiments;

FIG. 9 is a flow diagram presenting a method for making, for a communication device, an antenna assembly that combines a patch antenna within a coil for reduced two-dimensional spatial footprint of a first “in-plane” configuration, according to one or more embodiments; and

FIG. 10 is a flow diagram presenting a method for making, for a communication device, an alternate antenna assembly that combines a patch antenna within a coil for a reduced two-dimensional spatial footprint of a second “off-plane” configuration, according to one or more embodiments.

### DETAILED DESCRIPTION

According to aspects of the present disclosure, a communication device includes an antenna assembly of a patch antenna positioned within a coil extending around a perimeter to achieve a reduced spatial footprint, without significant degradation of antenna gain of the patch antenna. In particular implementations, techniques are provided for integrating a patch antenna configured for global positioning system (GPS) reception, satellite communication (e.g., IRIDIUM), or ultra-wideband (UWB) communication within a coil. The coil may be configured for near field communication (NFC) or wireless charging (WLC). The benefit of positioning the patch antenna within the coil is providing an antenna assembly having reduced spatial footprint as compared to a separate coil and a separate patch antenna. The effect of the proximity of the coil to the patch antenna is determined to be an acceptable 1 dB reduction in peak antenna gain of the patch antenna.

According to one or more embodiments, an antenna assembly includes a first ground plane. The antenna assembly includes a first ferrite layer positioned on and supported by the first ground plane. The antenna assembly includes a coil positioned over and supported by the first ferrite layer and having a first interior perimeter edge. The antenna assembly includes a patch antenna having a first footprint size that is smaller than, and positioned within, the first interior perimeter edge of the coil.

According to one or more embodiments, a communication device includes the antenna assembly. The smaller antenna assembly may be positioned toward an upper portion of a back side of a mobile communication device, matching user expectations for use of an NFC device but without complicating the design for placement of cameras and other devices.

According to one or more embodiments, a method for making an antenna assembly combines a patch antenna within a coil to provide a reduced two-dimensional spatial footprint for integration into a communication device with limited space for coils/antennas. In one or more embodiments, the method includes attaching a first ferrite layer to a first ground plane. The first ferrite layer is positioned on and supported by the first ground plane. The method includes attaching a coil, having an interior perimeter edge, to the first ferrite layer, the coil positioned over and supported by the first ferrite layer. The method includes coupling a patch antenna to the first ground plane, the patch antenna having a first footprint size that is smaller than, and positioned within, a first interior perimeter edge of the coil.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc., do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

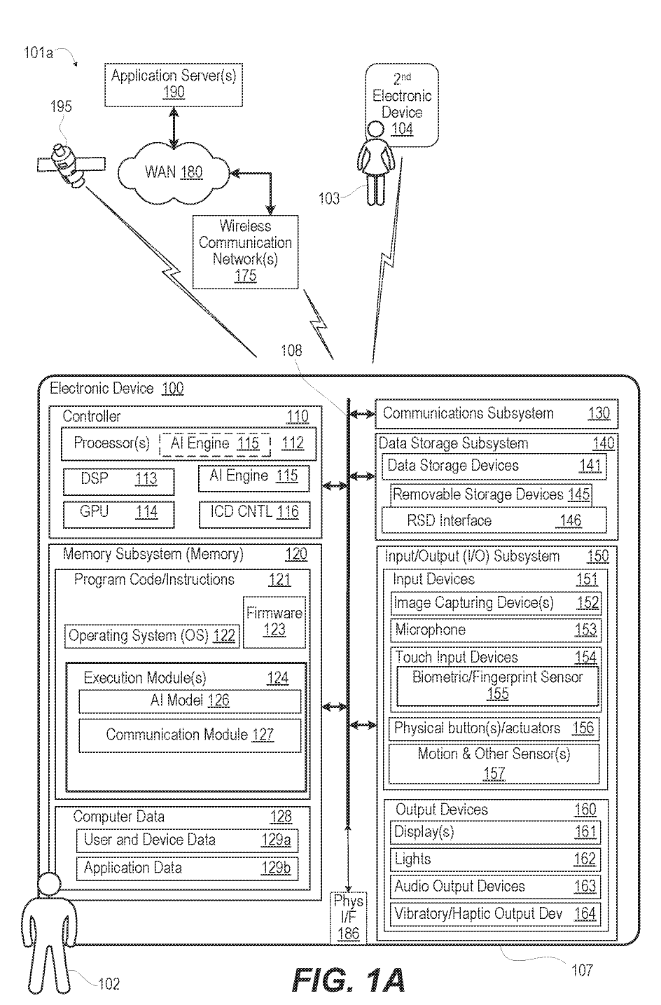

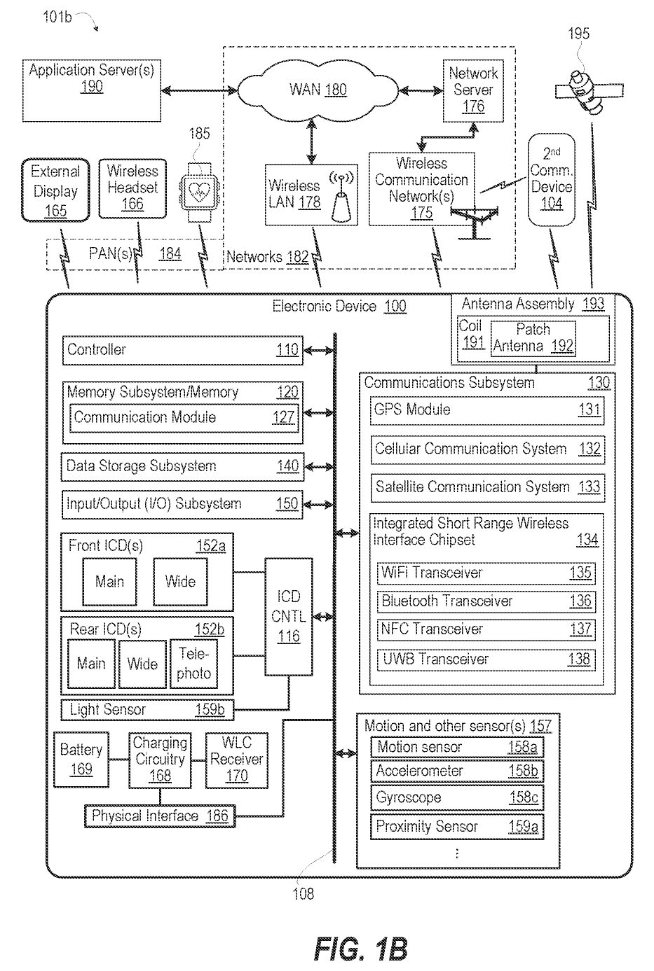

Those of ordinary skill in the art will appreciate that the hardware components and basic configuration depicted in the following figures may vary. For example, the illustrative components within electronic device 100 (FIG. 1A – 1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101 a and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, a heads up display (e.g., smart glasses) worn by user 102, and other types of electronic devices. For purposes of this disclosure, electronic device is assumed to be a communication device that can be used to communicate with second user(s) 103 who use corresponding second electronic device(s) 104. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 107. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122 .

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 includes, without limitation, communication module 127, which provides the features and operating functionality of the disclosed embodiments when the corresponding program instructions of communication module 127 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within communication module 127 and is trained to support the AI features of communication module 127. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of AI model(s) 126 and communication module 127, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 107. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user’s tactile/touch input. As a touch screen device, integrated display 161 allows a user to provide input to and/or to control electronic device 100 by touching features within a user interface presented on integrated display 161. Tactile touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 107 along with front image capturing devices (not specifically shown), while the higher quality ICDs are located on a rear surface of device housing 107. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. The antennas may include thin RF antennas positioned along edges of housing 107 that support cellular and Wi-Fi communications. According to aspects of the present disclosure, the antennas include antenna assembly 193 discussed below that require positioning on a larger space (e.g., back) on housing 107. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of communication module 127 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 186. Physical interface 186 of electronic device 100 can serve as an input/output data port and can be used as a power supply port that is coupled to charging circuitry 168 which feeds electrical power to device battery 169 to enable recharging of device battery 169 and/or powering of electronic device 100. Alternatively, or in addition, Wireless charging (WLC) receiver 170 may include one or more magnetic loop antennas in which a current is induced by receiving an oscillating magnetic field (e.g., coil 191 of FIG. 1B). WLC receiver 170 provides the current to charging circuit 168. As a data port, physical interface 186 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

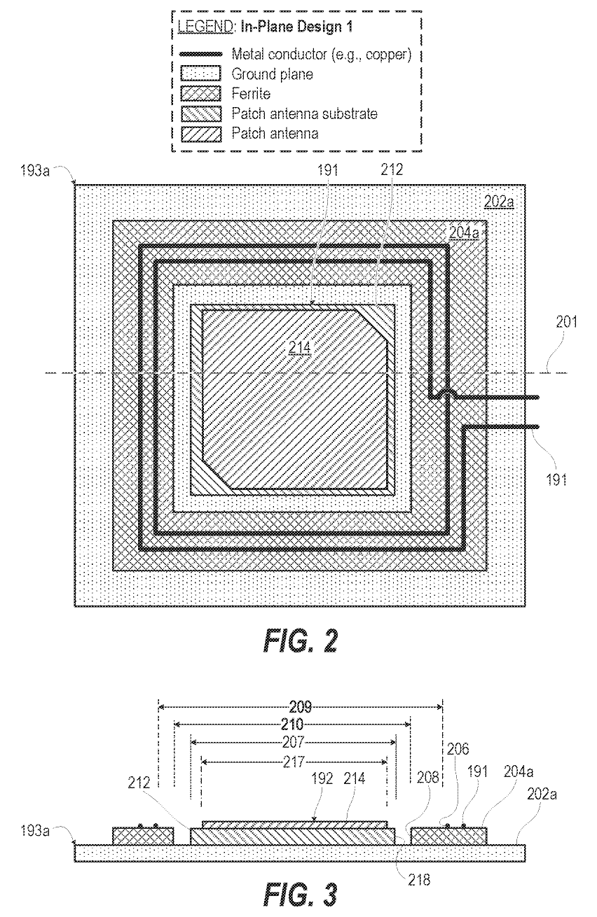

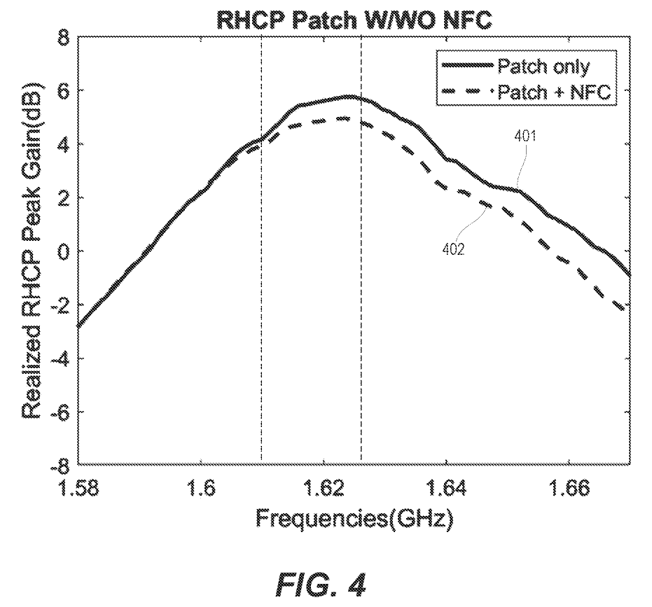

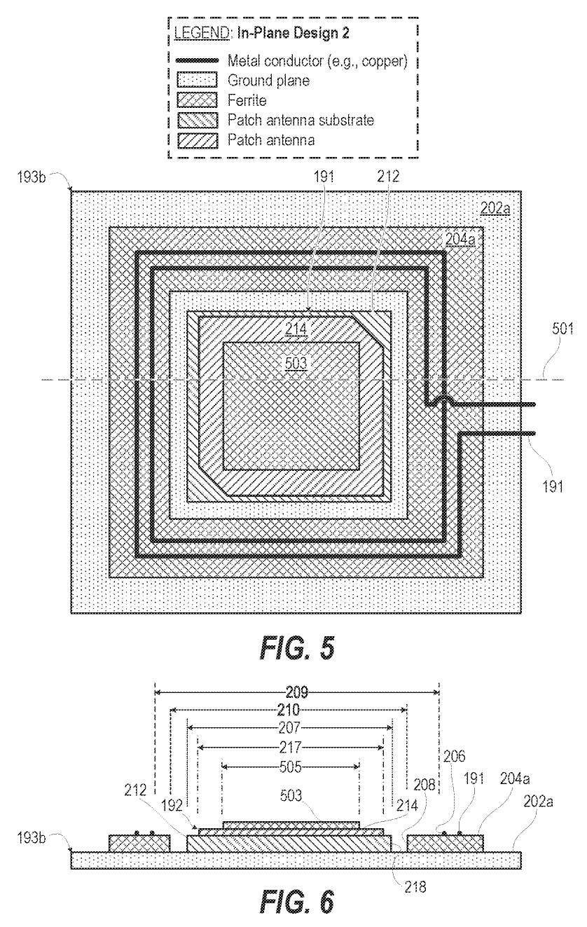

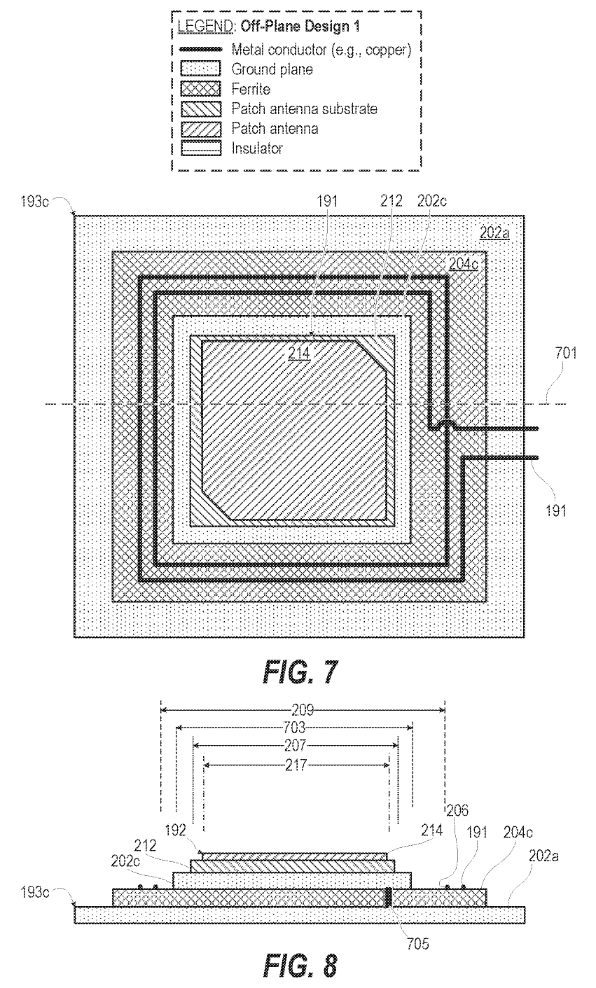

In one or more embodiments, electronic device 100 combines many of the above described components within a design form of a portable or handheld mobile communication device. Certain components of communications subsystem 130, such as coil 191, require a significant two-dimensional spatial footprint to generate sufficient magnetic flux. In an example, coil 191 supports NFC transceiver 137 and/or WLC receiver 170. The present disclosure recognizes that an interior portion within coil 191 may be used to position patch antenna 192 within coil 191 to form antenna assembly 193. Antenna assembly 193 has a smaller two-dimensional footprint than an implementation of a separate coil and a separate patch antenna. Patch antenna 192 may support one or more of GPS module 131, satellite communication system 133, and UWB transceiver 138. Integration of coil 191 and patch antenna 192 in antenna assembly 193 is achieved without significant degradation of antenna gain of patch antenna 192, as described below with regard to FIG. 4. Three embodiments of antenna assembly (collectively “193”) are described below: (i) first antenna assembly 193a (FIGS. 2 – 3); (ii) second antenna assembly 193b (FIGS. 5 – 6); and (iii) third antenna assembly 193c (FIGS. 7 – 8).

FIG. 2 is a top view of first antenna assembly 193a including patch antenna 192 positioned “in plane” with coil 191 by being supported by only one ground plane (i.e., first ground plane 202a). FIG. 3 is a side view of first antenna assembly 193a cutaway along line 201 of FIG. 2. With reference to both FIGS. 2 – 3, first ferrite layer 204a is positioned on and supported by first ground plane 202a. Coil 191 is positioned over and supported by first ferrite layer 204a and has first interior perimeter edge 206. In one or more embodiments, coil 191 is configured for at least one of radio frequency (RF) transceiving or electromagnetic energy transfer. In one or more embodiments, coil 191 is configured to perform functions of at least one of a near field communication (NFC) antenna and a wireless charging (WLC) coil. Patch antenna 192 has first footprint size 207 that is smaller than, and positioned within, first interior perimeter edge 206 (i.e., coil space 209) of coil 191. First ferrite layer 204a has second interior perimeter edge 208 (FIG. 3) presenting inner aperture 210. Patch antenna 192 has substrate 212 including a dielectric material positioned on and supported by first ground plane 202a within first interior perimeter edge 206 of coil 191 and within inner aperture 210 of first ferrite layer 204a. Patch antenna 192 includes conductive radiator patch 214 positioned on and supported by substrate 212. Patch radiator footprint 217 is smaller than first footprint size 207 of substrate 212. Outer edge 218 of patch antenna 192 is spaced inwardly at least 1 mm from first interior perimeter edge 206 of coil 191. Patch antenna 192 may be configured to perform functions of one or more of a global positioning system antenna, a satellite communication antenna, and an ultra-wideband (UWB) antenna.

FIG. 4 illustrates graphical plots 401 – 402, respectively, of realized peak gain in decibels as a function of frequency of a right hand circular polarized (RHCP) patch antenna with and without an integrated near field communication (NFC) antenna. Presence of the patch antenna only reduces realized peak gain by 1 dB, which is an acceptable degradation to gain the benefit of reduced size. Comparable benefits in size versus realized peak gain is expected for each embodiment.

FIG. 5 is a top view of second antenna assembly 193b including patch antenna 192 positioned “in plane” with coil 191 by being supported by only one ground plane (i.e., first ground plane 202a). FIG. 6 is a side view of second antenna assembly 193b cutaway along line 501 of FIG. 5. Second antenna assembly 193b is identical to first antenna assembly 193a but additionally includes second ferrite layer 503 having second footprint 505 with a size that is smaller than patch antenna 192 (i.e., smaller than patch radiator footprint 217) and positioned on and supported by the patch antenna.

FIG. 7 is a top view of third antenna assembly 193c including patch antenna 192 positioned “off plane” with coil 191 being directly supported by second ground plane 202c and indirectly supported by first ground plane 202a. FIG. 8 is a side view of third antenna assembly 193b cutaway along line 701 of FIG. 7. With reference to both FIGS. 7 – 8, first ferrite layer 204c is positioned on and supported by first ground plane 202a. First ferrite layer 204c does not include an aperture. Coil 191 is positioned over and supported by first ferrite layer 204c and has first interior perimeter edge 206. Second ground plane 202c has third footprint 703 that is sized smaller than and positioned within first interior perimeter edge 206 of coil 191. Second ground plane 202c is positioned on and supported by first ferrite layer 204c. Second ground plane 202c is electrically coupled via ground conductor 705 to first ground plane 202a. Substrate 212 of patch antenna 192 is positioned on and supported by second ground plane 202c. Conductive radiator patch 214 of patch antenna 192 is positioned on and supported by substrate 212.

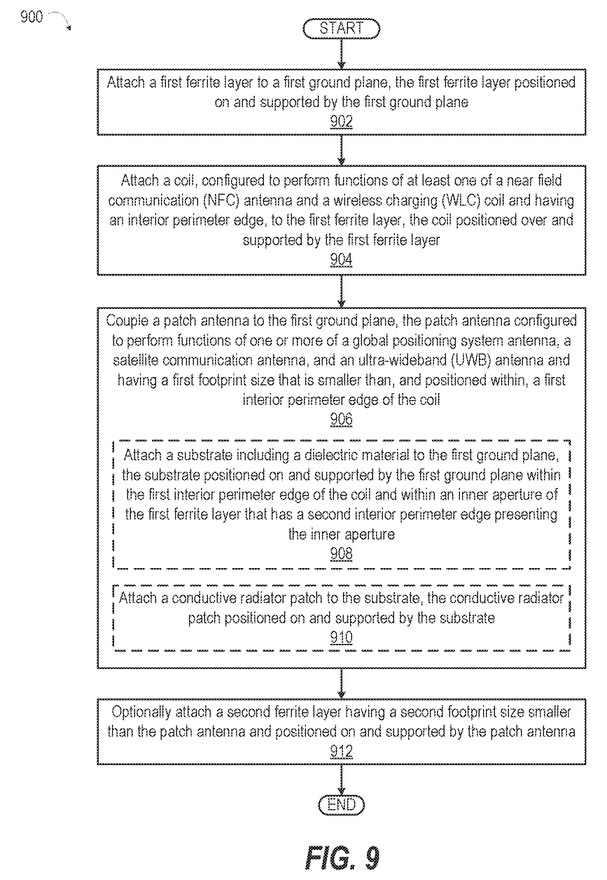

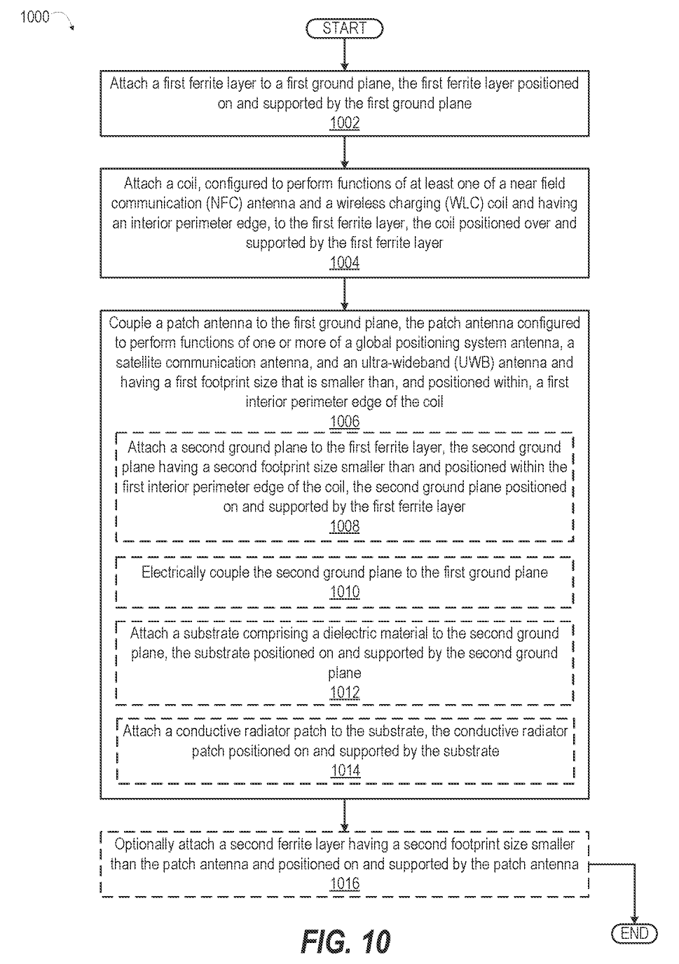

FIG. 9 is a flow diagram presenting method 900 for making, for a communication device, an antenna assembly that combines a coil and a patch antenna in reduced footprint of a first “in-plane” configuration. FIG. 10 is a flow diagram presenting method 1000 for making, for a communication device, an alternate antenna assembly that combines a coil and a patch antenna in reduced footprint of a second “off-plane” configuration. The descriptions of method 900 (FIG. 9) and method 1000 (FIG. 10) are provided with general reference to the specific components illustrated within the preceding FIGS. 1A – 1B and 2 – 8. Specific components referenced in method 900 (FIG. 9) and method 1000 (FIG. 10) may be identical or similar to components of the same name used in describing preceding FIGS. 1A – 1B and 2 – 8. In one or more embodiments, controller 110 (FIG. 1A) configures electronic device 100 (FIGS. 1A – 1B) or a similar computing device to provide the described functionality of method 900 (FIG. 9) and method 1000 (FIG. 10).

With reference to FIG. 9, method 900 includes attaching a first ferrite layer to a first ground plane, the first ferrite layer positioned on and supported by the first ground plane (block 902). Method 900 includes attaching a coil to the first ferrite layer, the coil positioned over and supported by the first ferrite layer and configured to perform functions of at least one of a near field communication (NFC) antenna and a wireless charging (WLC) coil and having an interior perimeter edge(block 904). Method 900 includes coupling a patch antenna to the first ground plane, the patch antenna configured to perform functions of one or more of a global positioning system antenna, a satellite communication antenna, and an ultra-wideband (UWB) antenna and having a first footprint size that is smaller than, and positioned within, a first interior perimeter edge of the coil (block 906). In an example, coupling the patch antenna to the first ground plane of block 906 may include performing processes of blocks 908 and 910. Method 900 optionally includes attaching a substrate including a dielectric material to the first ground plane, the substrate positioned on and supported by the first ground plane within the first interior perimeter edge of the coil and within an inner aperture of the first ferrite layer that has a second interior perimeter edge presenting the inner aperture (block 908). Method 900 includes attaching a conductive radiator patch to the substrate, the conductive radiator patch positioned on and supported by the substrate (block 910). Method 900 optionally includes attaching a second ferrite layer having a second footprint size smaller than the patch antenna and positioned on and supported by the patch antenna (block 912). Then method 1000 ends.

With reference to FIG. 10, method 1000 includes attaching a first ferrite layer to a first ground plane, the first ferrite layer positioned on and supported by the first ground plane (block 1002). Method 1000 includes attaching a coil having an interior perimeter edge, to the first ferrite layer, the coil positioned over and supported by the first ferrite layer and configured to perform functions of at least one of a near field communication (NFC) antenna and a wireless charging (WLC) coil (block 1004). Method 1000 includes coupling a patch antenna to the first ground plane, the patch antenna having a first footprint size that is smaller than, and positioned within, a first interior perimeter edge of the coil, the patch antenna configured to perform functions of one or more of a global positioning system antenna, a satellite communication antenna, and an ultra-wideband (UWB) antenna (block 1006). In an example, method 1000 includes coupling the patch antenna to the first ground plane by performing processes of blocks 1008, 1010 and 1012, one or more of which can be presented as an optional process. Method 1000 optionally includes attaching a second ground plane to the first ferrite layer, the second ground plane having a second footprint size smaller than and positioned within the first interior perimeter edge of the coil, the second ground plane positioned on and supported by the first ferrite layer (block 1008). Method 1000 includes electrically coupling the second ground plane to the first ground plane (block 1010). Method 1000 includes attaching a substrate comprising a dielectric material to the second ground plane, the substrate positioned on and supported by the second ground plane (block 1012). Method 1000 includes attaching a conductive radiator patch to the substrate, the conductive radiator patch positioned on and supported by the substrate (block 1014). Method 1000 optionally includes attaching a second ferrite layer having a second footprint size smaller than the patch antenna and positioned on and supported by the patch antenna (block 1016). Then method 1000 ends.

According to aspects of the present disclosure, the electronic device 100 (FIG. 1A), antenna assembly 193 (FIG. 1B), method 900 (FIG. 9), and method 1000 (FIG. 10) provide techniques for integrating a patch antenna configured for global positioning system (GPS) reception, satellite communication (e.g., IRIDIUM), or ultra-wideband (UWB) communication within a coil configured for near field communication (NFC) or wireless charging (WLC). The benefit of this technique is to provide an antenna assembly of both a coil and patch antenna that has reduced spatial footprint of the two separately. The effect of the proximity of coil to the patch antenna is determined to be only 1 dB reduction in peak antenna gain of the patch antenna. The smaller antenna assembly may be positioned toward an upper portion of a back side of a mobile communication device, matching user expectations for use of an NFC device but without complicating the design for placement of cameras and other devices.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc., do not denote any order or importance, but rather the terms first, second, etc. are used to distinguish one element from another.

The terminology used herein is for the purpose of describing particular embodiments only and is not intended to be limiting of the innovation. As used herein, the singular forms "a", "an" and "the" are intended to include the plural forms as well, unless the context clearly indicates otherwise. It will be further understood that the terms "comprise" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An antenna assembly comprising:
a first ground plane;
a first ferrite layer positioned on and supported by the first ground plane;
a coil positioned over and supported by the first ferrite layer and having a first interior perimeter edge; and
a patch antenna having a first footprint size that is smaller than, and positioned within, the first interior perimeter edge of the coil.

2. The antenna assembly of claim 1, wherein the coil is configured for at least one of radio frequency (RF) transceiving or electromagnetic energy transfer.

3. The antenna assembly of claim 2, wherein the coil is configured to perform functions of at least one of a near field communication (NFC) antenna and a wireless charging (WLC) coil.

4. The antenna assembly of claim 1, wherein an outer edge of the patch antenna is spaced inwardly at least 1 mm from the first interior perimeter edge of the coil.

5. The antenna assembly of claim 1, wherein the patch antenna is configured to perform functions of one or more of a global positioning system antenna, a satellite communication antenna, and an ultra-wideband (UWB) antenna.

6. The antenna assembly of claim 1, further comprising:
a second ferrite layer having a second footprint size smaller than the patch antenna and positioned on and supported by the patch antenna.

7. The antenna assembly of claim 1, wherein:
the first ferrite layer has a second interior perimeter edge presenting an inner aperture; and
the patch antenna comprises:
a substrate comprising a dielectric material positioned on and supported by the first ground plane within the first interior perimeter edge of the coil and within the inner aperture of the first ferrite layer; and
a conductive radiator patch positioned on and supported by the substrate.

8. The antenna assembly of claim 1, further comprising:
a second ground plane having a third footprint size smaller than and positioned within the first interior perimeter edge of the coil, the second ground plane positioned on and supported by the first ferrite layer, and electrically coupled to the first ground plane, wherein the patch antenna comprises:
a substrate comprising a dielectric material positioned on and supported by the second ground plane; and
a conductive radiator patch positioned on and supported by the substrate.

9. A communication device comprising:
an antenna assembly comprising:
a first ground plane;
a first ferrite layer positioned on and supported by the first ground plane;
a coil positioned over and supported by the first ferrite layer and having a first interior perimeter edge; and
a patch antenna having a first footprint size that is smaller than, and positioned within, the first interior perimeter edge of the coil.

10. The communication device of claim 9, wherein the coil is configured to perform functions of at least one of a near field communication (NFC) antenna and a wireless charging (WLC) coil.

11. The communication device of claim 9, wherein the patch antenna is configured to perform functions of one or more of a global positioning system antenna, a satellite communication antenna, and an ultra-wideband (UWB) antenna.

12. The communication device of claim 9, wherein the antenna assembly further comprises:
a second ferrite layer having a smaller footprint size than the patch antenna and positioned on and supported by the patch antenna.

13. The communication device of claim 9, wherein the antenna assembly further comprises:
the first ferrite layer has a second interior perimeter edge presenting an inner aperture; and
the patch antenna comprises:
a substrate comprising a dielectric material positioned on and supported by the first ground plane within the first interior perimeter edge of the coil and within the inner aperture of the first ferrite layer; and
a conductive radiator patch positioned on and supported by the substrate.

14. The communication device of claim 9, wherein the antenna assembly further comprises:
a second ground plane having a second footprint size smaller than and positioned within the first interior perimeter edge of the coil, the second ground plane positioned on and supported by the first ferrite layer, and electrically coupled to the first ground plane, wherein the patch antenna comprises:
a substrate comprising a dielectric material positioned on and supported by the second ground plane; and
a conductive radiator patch positioned on and supported by the substrate.

15. A method comprising:
attaching a first ferrite layer to a first ground plane, the first ferrite layer positioned on and supported by the first ground plane;
attaching a coil, having an interior perimeter edge, to the first ferrite layer, the coil positioned over and supported by the first ferrite layer; and
coupling a patch antenna to the first ground plane, the patch antenna having a first footprint size that is smaller than, and positioned within, a first interior perimeter edge of the coil.

16. The method of claim 15, wherein the coil is configured to perform functions of at least one of a near field communication (NFC) antenna and a wireless charging (WLC) coil.

17. The method of claim 15, wherein the patch antenna is configured to perform functions of one or more of a global positioning system antenna, a satellite communication antenna, and an ultra-wideband (UWB) antenna.

18. The method of claim 15, further comprising:
attaching a second ferrite layer having a second footprint size smaller than the patch antenna and positioned on and supported by the patch antenna.

19. The method of claim 15 wherein the first ferrite layer has a second interior perimeter edge presenting an inner aperture, and the method further comprises:
the patch antenna comprises:
attaching a substrate comprising a dielectric material to the first ground plane, the substrate positioned on and supported by the first ground plane within the first interior perimeter edge of the coil and within the inner aperture of the first ferrite layer; and
attaching a conductive radiator patch to the substrate, the conductive radiator patch positioned on and supported by the substrate.

20. The method of claim 15, further comprising:
attaching a second ground plane to the first ferrite layer, the second ground plane having a second footprint size smaller than and positioned within the first interior perimeter edge of the coil, the second ground plane positioned on and supported by the first ferrite layer;
electrically coupling the second ground plane to the first ground plane;
attaching a substrate comprising a dielectric material to the second ground plane, the substrate positioned on and supported by the second ground plane; and
attaching a conductive radiator patch to the substrate, the conductive radiator patch positioned on and supported by the substrate.
